(19) United States
(12) Patent Application Publication
(10) Pub. No.: US 2025/0214899 A1
(43) Pub. Date: Jul. 3, 2025

(54) Reclaim Composition Having Enhanced Properties

(71) Applicant: Gold Bond Building Products, LLC, Charlotte, NC (US)

(72) Inventors: Joseph J. Bailey, Charlotte, NC (US); Ratnasabapathy Gurunathan Iyer, Charlotte, NC (US); Alex Adams, Charlotte, NC (US)

(21) Appl. No.: 18/985,813

(22) Filed: Dec. 18, 2024

Related U.S. Application Data
(60) Provisional application No. 63/615,348, filed on Dec. 28, 2023.

(51) Int. Cl. C04B 28/14; C04B 18/167

(52) U.S. Cl. CPC C04B 28/14; C04B 18/167

(57) ABSTRACT

The present invention is generally directed to a method of processing reclaim gypsum panels and/or pieces thereof. In one aspect, the method may include grinding a reclaim gypsum panel and/or pieces thereof into ground reclaim material and separating the ground reclaim material into two or more reclaim compositions. The two or more reclaim compositions may include a first reclaim composition and a second reclaim composition. A reclaim enhancing additive may be applied to the first reclaim composition such that the reclaim enhancing additive penetrates at least a portion of the thickness of the reclaimed gypsum of the first reclaim composition.

### RELATED APPLICATIONS

The present application is based on and claims priority to U.S. Provisional Patent Application Ser. No. 63/615,348, filed on Dec. 28, 2023, which is incorporated herein by reference in its entirety.

### BACKGROUND OF THE INVENTION

In modern times, corporate sustainability initiatives and national environmental initiatives have become increasingly prominent and influential. Notably, the waste management of manufacturing processes has become a growing concern as manufacturers adjust their processes to better respond to environmental concerns of the manufacturer itself, the public, and administrative or governmental entities. As such, gypsum panel manufacturers have engaged in various corporate sustainability initiatives including the incorporation of reclaim gypsum panel components (e.g., waste gypsum panel components) in newly formed gypsum panels.

Generally, reclaim or waste gypsum panels are ground and processed to have one or more properties or characteristics that may be desirable for incorporation into new gypsum panels or for other applications. Notably, during the grinding of reclaim gypsum panels, airborne particles may be produced that may present a health hazard. Further, airborne particles may be produced after the grinding or milling of the reclaim gypsum panels, such as during the transportation of the ground reclaim material via a conveyor belt.

Additionally, and more generally, gypsum panel manufacturers have had difficulty utilizing components of reclaim gypsum panels in various applications, such as manufacturing newly formed gypsum panels, because the properties and characteristics of ground reclaim material may not be desirable for incorporation into new gypsum panels.

As a result, there is a need for an improved method of processing reclaim gypsum panels that may decrease the amount of airborne particles produced from the ground reclaim material and/or may enhance the properties and/or characteristics of the ground reclaim material. Additionally, there is a need for an enhanced reclaim composition utilized to form new gypsum panels.

### SUMMARY OF THE INVENTION

Aspects and advantages of the invention will be set forth in part in the following description, or may be obvious from the description, or may be learned through practice of the invention.

In accordance with one embodiment of the present invention, a method of processing a reclaim gypsum panel and/or pieces thereof is disclosed. The method comprises: grinding a reclaim gypsum panel and/or pieces thereof into ground reclaim material, the ground reclaim material comprising reclaimed gypsum and reclaimed facing material; and separating the ground reclaim material into two or more reclaim compositions, the two or more reclaim compositions comprising a first reclaim composition and a second reclaim composition, the first reclaim composition comprising the reclaimed gypsum in an amount of more than about 50 wt. % and the second reclaim composition comprising the reclaimed gypsum in an amount of less than about 50 wt. %; wherein a reclaim enhancing additive is applied to the first reclaim composition such that the reclaim enhancing additive penetrates at least a portion of the thickness of the reclaimed gypsum of the first reclaim composition.

Notably, the reclaim enhancing additive may be sprayed on the first reclaim composition. In some aspects, the application of the reclaim enhancing additive to the first reclaim composition may reduce the amount of airborne dust present in the air adjacent the first reclaim composition.

Generally, the reclaim enhancing additive may comprise water in an amount of about 50 wt. % or more. For instance, the reclaim enhancing additive may comprise water in an amount of about 80 wt. % or more. In some aspects, the reclaim enhancing additive may have a solids content of about 20 wt. % or less.

In general, the first reclaim composition may comprise reclaimed facing material. The reclaimed facing material may comprise reclaimed paper. The reclaimed paper may be present in the first reclaim composition in an amount of less than about 10 wt. %. For instance, reclaimed paper may be present in the first reclaim composition in an amount of less than about 5 wt. %.

In some aspects, the reclaim enhancing additive may comprise a polyol. In some aspects, the reclaim enhancing additive may comprise a phosphorus containing additive.

In accordance with another embodiment of the present invention, a method of processing a reclaim gypsum panel and/or pieces thereof is disclosed. The method comprises: grinding a reclaim gypsum panel and/or pieces thereof into ground reclaim material, the ground reclaim material comprising reclaimed gypsum and reclaimed facing material; and separating the ground reclaim material into two or more reclaim compositions, the two or more reclaim compositions comprising a first reclaim composition and a second reclaim composition, the first reclaim composition comprising the reclaimed gypsum in an amount of more than about 50 wt. % and the second reclaim composition comprising the reclaimed gypsum in an amount of less than about 50 wt. %; calcining the first reclaim composition; wherein a reclaim enhancing additive is applied to the first reclaim composition such that the reclaim enhancing additive penetrates at least a portion of the thickness of the reclaimed gypsum of the first reclaim composition.

In accordance with a further embodiment of the present invention, a method of processing a reclaim gypsum panel and/or pieces thereof is disclosed. The method comprises: grinding a reclaim gypsum panel and/or pieces thereof into ground reclaim material, the ground reclaim material comprising reclaimed gypsum and reclaimed facing material; and separating the ground reclaim material into two or more reclaim compositions, the two or more reclaim compositions comprising a first reclaim composition and a second reclaim composition, the first reclaim composition comprising the reclaimed gypsum in an amount of more than about 50 wt. % and the second reclaim composition comprising the reclaimed gypsum in an amount of less than about 50 wt. %; wherein a reclaim enhancing additive is applied to the reclaim gypsum panel and/or pieces thereof before and/or during the grinding of the reclaim gypsum panel and/or pieces thereof.

In accordance with an additional embodiment of the present invention, a method of processing a reclaim gypsum panel and/or pieces thereof is disclosed. The method comprises: grinding a reclaim gypsum panel and/or pieces thereof into ground reclaim material, the ground reclaim material comprising reclaimed gypsum and reclaimed facing material; and separating the ground reclaim material into two or more reclaim compositions, the two or more reclaim compositions comprising a first reclaim composition and a second reclaim composition, the first reclaim composition comprising the reclaimed gypsum in an amount of more than about 50 wt. % and the second reclaim composition comprising the reclaimed gypsum in an amount of less than about 50 wt. %, the second reclaim composition comprising the reclaimed facing material; wherein a reclaim enhancing additive is applied to the first reclaim composition and/or the second reclaim composition such that the reclaim enhancing additive penetrates at least a portion of the thickness of the reclaimed gypsum of the first reclaim composition and/or the reclaimed facing material of the second reclaim composition.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a method that enhances the properties and/or characteristics of reclaimed gypsum and/or reclaimed facing material and is further directed to an enhanced reclaim composition. The enhanced reclaim composition may be incorporated into a gypsum slurry and more generally a gypsum panel. Notably, the enhanced reclaim composition can include reclaimed gypsum, reclaimed facing material, one or more reclaim enhancing additives, and may include other optional additives. The present inventors have discovered that the enhanced reclaim composition and its corresponding method of formation disclosed herein can have various benefits. For instance, the method disclosed herein may decrease the amount of airborne particles produced from the grinding or milling of reclaim gypsum panels and/or pieces thereof and/or the transportation of ground reclaim material, and may enhance various properties and characteristics of a reclaim composition.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that, unless stated otherwise, any standard listed herein (e.g., ASTM) is the most recent version available as of the latest revision year. Notably, some aspects of the present disclosure may omit one or more of the features disclosed herein.

Generally, an enhanced reclaim composition may include reclaimed gypsum, reclaimed facing material, and/or one or more reclaim enhancing additives. As used herein, an “enhanced reclaim composition” is a reclaim composition that has had a reclaim enhancing additive applied thereto and/or incorporated therein. In general, an enhanced reclaim composition may be calcined or uncalcined. Notably, in one aspect, a reclaim enhancing additive may be applied (e.g., sprayed, misted, fogged, dripped) to a reclaim gypsum panel and/or pieces thereof before the reclaim gypsum panel and/or pieces thereof are ground or milled into a ground reclaim material. As used herein, “ground reclaim material” refers to the material resulting from the grinding or milling of a reclaim gypsum panel and/or pieces thereof but before the separation of the material into one or more reclaim compositions. In another aspect, a reclaim enhancing additive may be applied to a reclaim gypsum panel and/or pieces thereof during the grinding or milling of the reclaim gypsum panel and/or pieces thereof. In this respect, the grinding or milling of a reclaim gypsum panel and/or pieces thereof and the application and/or incorporation of the reclaim enhancing additive may occur simultaneously. In yet another aspect, a reclaim enhancing additive may be applied to a reclaim gypsum panel and/or pieces thereof before the reclaim gypsum panel and/or pieces thereof are ground or milled and during the grinding or milling of the reclaim gypsum panel and/or pieces thereof.

In one aspect, a reclaim enhancing additive may be applied (e.g., sprayed, misted, fogged) to and/or incorporated in a reclaim composition and/or any component thereof (e.g., reclaimed gypsum, reclaimed facing material) after a reclaim gypsum panel and/or pieces thereof are ground or milled. For instance, a reclaim gypsum panel and/or pieces thereof may be ground or milled into a ground reclaim material. The ground reclaim material may then be separated into two or more reclaim compositions. In one aspect, the reclaimed gypsum and reclaimed facing material of the ground reclaim material may be at least partially separated to form two or more reclaim compositions. For instance, a first reclaim composition and a second reclaim composition may be formed. As previously disclosed herein, one or more reclaim compositions may be enhanced via a reclaim enhancing additive. Therefore, it should be understood that one or more enhanced reclaim compositions (e.g., first enhanced reclaim composition, second enhanced reclaim composition) may be formed. In some aspects, the same reclaim enhancing additive may be applied to and/or incorporated in two or more reclaim compositions. In some aspects, different reclaim enhancing additives may be applied to and/or incorporated in two or more reclaim compositions. In this respect, a first reclaim enhancing additive may be applied to and/or incorporated in the first reclaim composition, and a second reclaim enhancing additive that is different from the first reclaim enhancing additive may be applied to and/or incorporated in the second reclaim composition. Generally, the difference between two or more reclaim enhancing additives may be the components of the respective enhancing additives and/or the size (e.g., average particle size, particle size distribution) of the components of the two or more reclaim enhancing additives.

Notably, after the grinding or milling of the ground reclaim material and/or after the formation of two or more reclaim compositions, the ground reclaim material and/or two or more reclaim compositions may be transported via one or more feeders and/or one or more conveyor belts. In general, the ground reclaim material and/or two or more reclaim compositions may be transported to be calcined. In general, the ground reclaim material and/or two or more reclaim compositions may be transported to be incorporated and/or applied to a gypsum panel and/or any component thereof.

In general, the first reclaim composition may include reclaimed gypsum in an amount of about 50 wt. % to about 100 wt. %, including all increments of 0.01 wt. % therebetween. For instance, the first reclaim composition may include reclaimed gypsum in an amount of about 50 wt. % or more, such as about 60 wt. % or more, such as about 70 wt. % or more, such as about 80 wt. % or more, such as about 90 wt. % or more. In general, the first reclaim composition may include reclaimed gypsum in an amount of about 100 wt. % or less, such as about 90 wt. % or less, such as about 80 wt. % or less, such as about 70 wt. % or less, such as about 60 wt. % or less. It should be understood that the above-mentioned values may refer to the reclaimed gypsum content of a first enhanced reclaim composition.

In general, the first reclaim composition may include reclaimed facing material (e.g., reclaimed paper) in an amount of about 0 wt. % to about 50 wt. %, including all increments of 0.01 wt. % therebetween. For instance, the first reclaim composition may include reclaimed facing material in an amount of about 0 wt. % or more, such as about 10 wt. % or more, such as about 20 wt. % or more, such as about 30 wt. % or more, such as about 40 wt. % or more. In general, the first reclaim composition may include reclaimed facing material in an amount of about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less. It should be understood that the above-mentioned values may refer to the reclaimed facing material content of a first enhanced reclaim composition. Generally, the reclaimed facing material may include paper, glass fiber, polymers, one or more surfactants, or a combination thereof. The one or more surfactants of the reclaimed facing material may include one or more of the surfactants disclosed herein. In general, the reclaimed facing material may include ground or milled paper facing material, glass mat facing material, polymeric facing material, or a combination thereof.

In general, the second reclaim composition may include reclaimed facing material (e.g., reclaimed paper) in an amount of about 50 wt. % to about 100 wt. %, including all increments of 0.01 wt. % therebetween. For instance, the second reclaim composition may include reclaimed facing material in an amount of about 50 wt. % or more, such as about 60 wt. % or more, such as about 70 wt. % or more, such as about 80 wt. % or more, such as about 90 wt. % or more. In general, the second reclaim composition may include reclaimed facing material in an amount of about 100 wt. % or less, such as about 90 wt. % or less, such as about 80 wt. % or less, such as about 70 wt. % or less, such as about 60 wt. % or less. It should be understood that the above-mentioned values may refer to the reclaimed facing material content of a second enhanced reclaim composition. Generally, the reclaimed facing material may include paper, glass fiber, polymers, or a combination thereof. In general, the reclaimed facing material may include ground or milled paper facing material, glass mat facing material, polymeric facing material, or a combination thereof.

In general, the second reclaim composition may include reclaimed gypsum in an amount from about 0 wt. % to about 50 wt. %, including all increments of 0.01 wt. % therebetween. For instance, the second reclaim composition may include reclaimed gypsum in an amount of about 0 wt. % or more, such as about 10 wt. % or more, such as about 20 wt. % or more, such as about 30 wt. % or more, such as about 40 wt. % or more. In general, the second reclaim composition may include reclaimed gypsum in an amount of about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less. It should be understood that the above-mentioned values may refer to the reclaimed gypsum content of a second enhanced reclaim composition.

As previously disclosed herein, after the grinding or milling of a reclaim gypsum panel and/or pieces thereof, the ground reclaim material may be separated into one or more reclaim compositions. The one or more reclaim compositions may include reclaimed gypsum and/or reclaimed facing material. Notably, the reclaimed gypsum and the reclaimed facing material may be separated via size separation. For instance, in one aspect, one or more trommel screens may be utilized to separate the reclaimed gypsum from the reclaimed facing material. Further, for instance, one or more vibrating screens may be utilized to separate the reclaimed gypsum from the reclaimed facing material. Notably, the reclaimed gypsum and the reclaimed facing material may be separated via weight and/or density separation. For instance, in one aspect, one or more gravity tables may be utilized to separate the reclaimed gypsum from the reclaimed facing material. Additionally, drying may be utilized to facilitate the grinding, shredding, and/or separation of reclaim gypsum panels, ground reclaim material, and/or one or more reclaim compositions. In one aspect, the reclaimed gypsum and the reclaimed facing material may be separated by dissolving the reclaimed gypsum in a solution and retaining the reclaimed facing material (e.g., reclaimed paper). Notably, a solution containing dissolved gypsum (e.g., reclaimed gypsum) can be reused in the process as gauging water or for some other purpose. In this respect, a solution including dissolved gypsum may be incorporated and/or applied to a gypsum panel and/or any component thereof.

Notably, a reclaim enhancing additive may be applied to and/or incorporated in a reclaim composition (e.g., first reclaim composition, second reclaim composition) at any time of the process disclosed herein, including during, before, and/or after any of the process steps disclosed herein. In general, a reclaim enhancing additive may be applied to a reclaim composition by spraying, brushing, curtain coating, and/or roll coating.

In general, the reclaim enhancing additive may be sprayed via one or more nozzles. The one or more nozzles may be configured to atomize the reclaim enhancing additive into droplets. The application of the reclaim enhancing additive via spraying may reduce and/or mitigate the amount of dust produced by the grinding or milling of reclaim gypsum panels and/or pieces thereof and/or produced by the transportation (e.g., conveying via conveyor belt) of one or more reclaim compositions, particularly in comparison to a similar process without the use of a reclaim enhancing additive as disclosed herein. A reduction in the amount of dust may be particularly beneficial to lowering or eliminating the exposure of operators and/or the environment to airborne particles. Generally, the application of a reclaim enhancing additive to a reclaim composition may reduce the amount of airborne dust present in the air adjacent to and/or surrounding a reclaim composition, particularly in comparison to a similar process without the use of a reclaim enhancing additive as disclosed herein.

In some aspects, the reclaim enhancing additive may be applied (e.g., sprayed) such that at least a portion of the dust produced by the grinding or milling of a reclaim gypsum panel and/or pieces thereof and/or the transportation of a reclaim composition is reincorporated back into the reclaim gypsum panel and/or pieces thereof, a ground reclaim material, and/or a reclaim composition. In general, the reincorporation of dust back into a reclaim composition may be particularly beneficial. For instance, the reincorporation of dust back into a reclaim composition may enhance gypsum and/or stucco dissolution in a gypsum slurry.

In some aspects, the reclaim enhancing additive may be applied (e.g., sprayed) such that at least a portion of the dust produced by the grinding or milling of a reclaim gypsum panel and/or pieces thereof and/or the transportation of a reclaim composition is not reincorporated back into the reclaim gypsum panel and/or pieces thereof, a ground reclaim material, and/or a reclaim composition.

In some aspects, after application and/or incorporation of a reclaim enhancing additive in a reclaim composition, the enhanced reclaim composition may be incorporated into one or more gypsum slurries (e.g., first gypsum slurry, second gypsum slurry, third gypsum slurry). The one or more gypsum slurries may be dried to form a gypsum core and/or one or more gypsum core layers (e.g., first gypsum core layer, second gypsum core layer, third gypsum core layer).

In some aspects, after the application and/or incorporation of a reclaim enhancing additive in a reclaim composition, the enhanced reclaim composition may be milled and/or calcined. In general, an enhanced reclaim composition may be calcined during, before, and/or after any of the process steps disclosed herein. Generally, gypsum is calcined to form stucco for utilization in the formation of a gypsum panel. Various different types of mills may be used to dry and crush/grind the reclaimed gypsum, such as a Raymond mill, an imp mill, and other mills known in the art. Calcination may be carried out using a variety of different types of calciners, such as rotary kilns, kettles, impact mills, calcidynes, and other calciners known in the art. In some aspects, the reclaimed gypsum may be simultaneously ground and calcined (e.g., milled during calcination, such as in an imp mill). The calcination process is generally characterized by the following chemical reaction:

CaSO₄·2H₂O+heat→CaSO₄·½H₂O+1½H₂O (Hemihydrate)

Generally, this equation shows that calcium sulfate dihydrate plus heat yields calcium sulfate hemihydrate (stucco) plus water vapor. In one aspect, an enhanced reclaim composition containing reclaimed gypsum may be combined with virgin gypsum before being calcined.

In one aspect, the enhanced reclaim composition may be calcined by flash calcination, where the enhanced reclaim composition is exposed to elevated temperatures for very short periods of time. The enhanced reclaim composition may be placed in direct contact with a flow of high temperature gas, which may rapidly calcine the reclaimed gypsum of an enhanced reclaim composition to predominantly the calcium sulfate hemihydrate gypsum phase. Flash calcination may be carried out using a Calcidyne® process, impact (imp) mill (i.e., cage mills with energy added to accomplish flash drying/calcination), a Claudius Peters EM Mill, and other flash calcination systems known in the art. Notably, flash calcination is generally a rapid, continuous process with limited dwell times and low pressures, which may reduce the opportunity for degradation and loss of potency of the additives compared to conventional processes such as kettle or batch calcination that typically involve longer residence times under heat and pressure. The temperatures employed in flash calcination may range from about 350° C. to about 750° C., including all increments of 1° C. therebetween, which is generally higher than calcination systems such as kettle or rotary kiln calcination which generally have temperatures ranging from about 120° C. to about 260° C. The enhanced reclaim composition may be exposed to elevated temperatures for only a few seconds, whereas calcination using a rotary kiln or kettle may occur over a period of minutes to hours. The stucco produced by flash calcination commonly comprises multiple gypsum phases, and may be generally characterized by the following chemical reactions:

CaS0₄·2H₂O+heat→CaSO₄·½H₂O+1½H₂O (Hemihydrate)

CaS0₄·2H₂O+heat→CaS0₄ (AIII)+2H₂O (Soluble Anhydrite)

CaS0₄·2H₂O+heat→CaS0₄ (AII)+2H₂O (Insoluble Anhydrite)

Generally, these equations show that flash calcination may yield calcium sulfate hemihydrate (stucco), soluble anhydrite, and insoluble anhydrite, in addition to residual uncalcined gypsum.

In general, some additives may be particularly suitable for incorporation into a reclaim composition before calcination. For instance, some additives show secondary benefits with precalcination addition which may further reduce manufacturing costs, such as reducing stucco water demand and increasing slurry fluidity, and accelerating the rate of gypsum set. Additives that may exhibit reduced stucco water demand and that may be improved by precalcination addition, include: sodium phosphate monobasic, trisodium phosphate, sodium aluminum sulfate, ammonium phosphate monobasic, boric acid, calcium carbonate, potassium carbonate, calcium chloride, potassium chloride, ferric chloride, aluminum sulfate, tartaric acid, citric acid, Borax, sodium phosphate tribasic dodecahydrate, calcium phosphate dibasic, calcium nitrate tetrahydrate, urea, talc, and sodium metaborate.

In general, a reclaim enhancing additive may include sodium phosphate monobasic, trisodium phosphate, sodium aluminum sulfate, ammonium phosphate monobasic, calcium carbonate, potassium carbonate, calcium chloride, potassium chloride, ferric chloride, aluminum sulfate, tartaric acid, citric acid, Borax, sodium phosphate tribasic dodecahydrate, calcium phosphate dibasic, calcium nitrate tetrahydrate, urea, talc, sodium metaborate, or a combination thereof in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In general, the above-mentioned additives may be present in the reclaim enhancing additive in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

Generally, an enhanced reclaim composition may include sodium phosphate monobasic, trisodium phosphate, sodium aluminum sulfate, ammonium phosphate monobasic, calcium carbonate, potassium carbonate, calcium chloride, potassium chloride, ferric chloride, aluminum sulfate, tartaric acid, citric acid, Borax, sodium phosphate tribasic dodecahydrate, calcium phosphate dibasic, calcium nitrate tetrahydrate, urea, talc, sodium metaborate, or a combination thereof in an amount of 0.001 wt. % or more, such as 0.005 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the above-mentioned additives may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

Additionally, additives that may increase the rate of set and that may be improved by precalcination addition, include: sodium trimetaphosphate, ammonium polyphosphate, sodium phosphate tribasic, sodium aluminum sulfate, ammonium phosphate monobasic, ammonium phosphate dibasic, calcium chloride, potassium chloride, sodium phosphate tribasic dodecahydrate, calcium phosphate dibasic, potassium carbonate, ferric nitrate, boric acid, ammonium sulfate, calcium carbonate, potassium sulfate, calcium phosphate monobasic, potassium phosphate tribasic, aluminum sulfate, tartaric acid, Borax, calcium nitrate tetrahydrate, urea, talc, sodium metaborate, potash, and boric oxide.

In general, a reclaim enhancing additive may include sodium trimetaphosphate, ammonium polyphosphate, sodium phosphate tribasic, sodium aluminum sulfate, ammonium phosphate monobasic, ammonium phosphate dibasic, calcium chloride, potassium chloride, sodium phosphate tribasic dodecahydrate, calcium phosphate dibasic, potassium carbonate, ferric nitrate, boric acid, ammonium sulfate, calcium carbonate, potassium sulfate, calcium phosphate monobasic, potassium phosphate tribasic, aluminum sulfate, tartaric acid, Borax, calcium nitrate tetrahydrate, urea, talc, sodium metaborate, potash, boric oxide, or a combination thereof in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In general, the above-mentioned additives may be present in the reclaim enhancing additive in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

Generally, an enhanced reclaim composition may include sodium trimetaphosphate, ammonium polyphosphate, sodium phosphate tribasic, sodium aluminum sulfate, ammonium phosphate monobasic, ammonium phosphate dibasic, calcium chloride, potassium chloride, sodium phosphate tribasic dodecahydrate, calcium phosphate dibasic, potassium carbonate, ferric nitrate, boric acid, ammonium sulfate, calcium carbonate, potassium sulfate, calcium phosphate monobasic, potassium phosphate tribasic, aluminum sulfate, tartaric acid, Borax, calcium nitrate tetrahydrate, urea, talc, sodium metaborate, potash, boric oxide, or a combination thereof in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the above-mentioned additives may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

In general, additives may be utilized that may increase the compressive strength of a gypsum panel. For instance, additives that may increase the compressive strength of a gypsum panel may include ammonium phosphate monobasic, ammonium phosphate dibasic, aluminum phosphate, sodium aluminum sulfate, calcium chloride, potassium chloride, sodium hydroxide, sodium bicarbonate, potassium carbonate, sodium carbonate, ferric chloride, iron (III) nitrate nonahydrate (ferric nitrate), aluminum nitrate, boric acid, ammonium sulfate, potassium sulfate, boric oxide, sodium trimetaphosphate (STMP), sodium phosphate tribasic dodecahydrate, citric acid, Borax, sodium tripolyphosphate (STPP), ammonium polyphosphate (APP), sodium phosphate monobasic, sodium phosphate tribasic (trisodium phosphate), calcium phosphate monobasic, calcium phosphate tribasic, calcium carbonate, sodium phosphate tribasic dodecahydrate, calcium nitrate tetrahydrate, urea, talc, sodium acetate, or a combination thereof.

In general, a reclaim enhancing additive may include ammonium phosphate monobasic, ammonium phosphate dibasic, aluminum phosphate, sodium aluminum sulfate, calcium chloride, potassium chloride, sodium hydroxide, sodium bicarbonate, potassium carbonate, sodium carbonate, ferric chloride, iron (III) nitrate nonahydrate (ferric nitrate), aluminum nitrate, boric acid, ammonium sulfate, potassium sulfate, boric oxide, sodium trimetaphosphate (STMP), sodium phosphate tribasic dodecahydrate, citric acid, Borax, sodium tripolyphosphate (STPP), ammonium polyphosphate (APP), sodium phosphate monobasic, sodium phosphate tribasic (trisodium phosphate), calcium phosphate monobasic, calcium phosphate tribasic, calcium carbonate, sodium phosphate tribasic dodecahydrate, calcium nitrate tetrahydrate, urea, talc, sodium acetate, or a combination thereof in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In general, the above-mentioned additives may be present in the reclaim enhancing additive in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

Generally, an enhanced reclaim composition may include ammonium phosphate monobasic, ammonium phosphate dibasic, aluminum phosphate, sodium aluminum sulfate, calcium chloride, potassium chloride, sodium hydroxide, sodium bicarbonate, potassium carbonate, sodium carbonate, ferric chloride, iron (III) nitrate nonahydrate (ferric nitrate), aluminum nitrate, boric acid, ammonium sulfate, potassium sulfate, boric oxide, sodium trimetaphosphate (STMP), sodium phosphate tribasic dodecahydrate, citric acid, Borax, sodium tripolyphosphate (STPP), ammonium polyphosphate (APP), sodium phosphate monobasic, sodium phosphate tribasic (trisodium phosphate), calcium phosphate monobasic, calcium phosphate tribasic, calcium carbonate, sodium phosphate tribasic dodecahydrate, calcium nitrate tetrahydrate, urea, talc, sodium acetate, or a combination thereof in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the above-mentioned additives may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

### Phosphorus Containing Compounds

In general, a reclaim enhancing additive and/or an enhanced reclaim composition may include one or more phosphorus containing compounds. For instance, a reclaim enhancing additive and/or an enhanced reclaim composition may include one or more phosphates. In this respect, a reclaim enhancing additive and/or an enhanced reclaim composition may include sodium trimetaphosphate, sodium monofluorophosphate, sodium triphosphate, aluminum phosphate, aluminum polyphosphate, sodium phosphate monobasic, trisodium phosphate, ammonium phosphate monobasic, ammonium phosphate dibasic, sodium phosphate tribasic, sodium phosphate tribasic dodecahydrate, calcium phosphate monobasic, calcium phosphate dibasic, potassium phosphate tribasic, or a combination thereof.

In general, the phosphorus containing compound may be a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof. In one embodiment, the phosphorus containing compound comprises a phosphite or a salt thereof. In another embodiment, the phosphorus containing compound comprises a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof. In a further embodiment, the phosphorus containing compound comprises a combination of a phosphite or a salt thereof and a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof.

As indicated above, the phosphorus containing compound may be a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof. In this regard X may be hydrogen, halogen, or sulfur. For instance, X may be halogen or sulfur. In one embodiment, X may be sulfur. In a further embodiment, X may be selenium. In another embodiment, X may be hydrogen. In another embodiment, X may be halogen. For instance, the halogen may be fluorine (or fluoro), chlorine (or chloro), bromine (or bromo), iodine (or iodo), or any combination thereof. For instance, in one embodiment, the halogen may be fluorine (or fluoro). It should be noted that when m is greater than 1, each X may be independent of another X. That is, each X may be identical or alternatively, one X may be different from another X.

In addition, as indicated above, n is from 0 to 4, such as from 1 to 4, such as from 2 to 4, such as from 2 to 3. Thus, n may be at least 0, such as at least 1, such as at least 2, such as at least 3 to 4 or less, such as 3 or less, such as 2 or less, such as 1 or less. Thus, n may be 0. Further, n may be 1. In another embodiment, n may be 2. In a further embodiment, n may be 3. In another further embodiment, n may be 4.

Also, as indicated above, m is from 0 to 6, such as from 1 to 6, such as from 1 to 5, such as from 1 to 4, such as from 1 to 3, such as from 1 to 2 or 2 to 3. Thus, m may be at least 0, such as at least 1, such as at least 2, such as at least 3, such as at least 4, such as at least 5 to 6 or less, such as 5 or less, such as 4 or less, such as 3 or less, such as 2 or less, such as 1 or less. In this regard, m may be 1. In another embodiment, m may be 2. In a further embodiment, m may be 3. In another further embodiment, m may be 4. In one embodiment, m may be 5. Finally, in a further embodiment, m may be 6.

In addition, as indicated above, the sum of n and m may be from 3 to 6. In this regard, the sum of n and m may be at least 3, such as at least 4, such as at least 5 to 6 or less, such as 5 or less, such as 4 or less. In one embodiment, the sum of n and m may be 3. In another embodiment, the sum of n and m may be 4. In a further embodiment, the sum of n and m may be 5. In another further embodiment, the sum of n and m may be 6.

In one particular embodiment, X may be halogen, such as fluorine (fluoro), n may be 3, and m may be 1. In another particular embodiment, X may be halogen, such as fluorine (fluoro), n may be 2, and m may be 2. In this regard, when X is halogen, the phosphorus containing compound may be referred to as a halophosphate.

When the phosphorus containing compound comprises a halophosphate, the halo may be any halogen atom suitable for the present invention. In this regard, the halogen may be fluorine (or fluoro), chlorine (or chloro), bromine (or bromo), iodine (or iodo), or any combination thereof. For instance, in one embodiment, the halogen may be fluorine (or fluoro) such that the halophosphate is a fluorophosphate. In another embodiment, the halogen may be chlorine (or chloro) such that the halophosphate is a chlorophosphate.

Further, the halophosphate may comprise any number of halogen atoms. For instance, the halophosphate may include at least 1 halogen atom, such as at least 2 halogen atoms, such as at least 3 halogen atoms, such as at least 4 halogen atoms, such as at least 5 halogen atoms, such as at least 6 halogen atoms. In this regard, the halophosphate may be a monohalophosphate, a dihalophosphate, a trihalophosphate, a tetrahalophosphate, a pentahalophosphate, a hexahalophosphate, or any mixture thereof. In one embodiment, the halophosphate includes a monohalophosphate. In another embodiment, the halophosphate includes a dihalophosphate.

As indicated above, the halogen may be fluorine. In this regard, the halophosphate may be a fluorophosphate. In particular, the fluorophosphate may be a monofluorophosphate, a difluorophosphate, a trifluorophosphate, a tetrafluorophosphate, a pentafluorophosphate, a hexafluorophosphate, or any mixture thereof. In one embodiment, the fluorophosphate may include a monofluorophosphate. In another embodiment, the fluorophosphate may include a difluorophosphate.

As also indicated above, X may be a hydrogen. In this regard, m may be 1. In one embodiment, m may be 2 such that the phosphate is a dihydrogen phosphate. In a particular embodiment, the compound may be a bis (dihydrogen phosphate). In another particular embodiment, the compound may be a tris (dihydrogen phosphate).

As indicated above, the phosphorus containing compound may be a phosphite. For instance, the phosphite may be an anion having the general formula [HPO₃]²⁻. In this regard, the phosphite may be a salt of phosphorus acid. In one embodiment, the phosphite may have the formula of the aforementioned phosphate wherein X is H. The remaining parameters of such formula may be the same as defined above and herein with respect to the phosphate. For instance, in the above formula, n may be 3 and m may be 1.

Furthermore, the phosphorus containing compound may be a salt. In this regard, the phosphorus containing compound may include ammonium, a metal, or a combination thereof. In one embodiment, the phosphorus containing compound includes ammonium. In another embodiment, the phosphorus containing compound includes a metal.

When the phosphorus containing compound includes a metal, the metal may be any employed in the art. For instance, the metal may be an alkali metal, an alkaline earth metal, a transition metal, or a combination thereof. In one embodiment, the metal may be an alkali metal. For instance, the alkali metal may be lithium, sodium, potassium, or a combination thereof. In one particular embodiment, the alkali metal may be sodium, potassium, or a combination thereof. In another particular embodiment, the alkali metal may include sodium.

In another embodiment, the metal may be an alkaline earth metal. For instance, the alkaline earth metal may be beryllium, magnesium, calcium, strontium, barium, or a combination thereof. In one particular embodiment, the alkaline earth metal may be magnesium, calcium, or a combination thereof.

In a further embodiment, the metal may be a transition metal. For instance, the transition metal may be manganese, iron, cobalt, nickel, copper, zinc, titanium, chromium, platinum, gold, molybdenum, palladium, silver, tantalum, tungsten, etc., or a combination thereof.

In addition to alkali metals, alkaline earth metals, and transition metals, other metals may also be employed. For instance, the metal may be aluminum, indium, tin, bismuth, etc., or a combination thereof.

Furthermore, one mole of metal may be present. Alternatively, in one embodiment, two moles of metal may be present. As an example, the metal may simply be sodium. Alternatively, the metal may be disodium. In this regard, the number of moles of metal may depend on the charge of the anion. Thus, if the anion has a charge of −6, six moles of sodium may be required.

Notably, the phosphorus containing compound may be sodium monofluorophosphate. The salt includes when the components are present as ions of such compound or disassociated. For instance, a reclaim enhancing additive and/or an enhanced reclaim composition may comprise sodium and monofluorophosphate, which may not be complexed but instead may be uncomplexed or disassociated. Additionally, when disassociated, a reclaim enhancing additive and/or an enhanced reclaim composition may include one of the ions or both of the ions. Using the example of sodium monofluorophosphate, a reclaim enhancing additive and/or an enhanced reclaim composition may include sodium, monofluorophosphate, or both sodium and monofluorophosphate. In one embodiment, the phosphate component, such as the halofluorophosphate (e.g., monofluorophosphate), may complex with another cation or metal.

The phosphorus containing compound may be present in the reclaim enhancing additive in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

In one aspect, the phosphorus containing compound may be present in the enhanced reclaim composition in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the phosphorus containing compound may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

### Polyols

In general, a reclaim enhancing additive and/or an enhanced reclaim composition may include one or more polyols. In general, the polyol may be a polyol compound. For instance, the polyol compound may be a sugar, a sugar alcohol, a polyether, a polysaccharide, or a mixture thereof. In one embodiment, the polyol compound may include glycerol. In another embodiment, the polyol compound may include a sugar. In a further embodiment, the polyol compound may include a sugar alcohol. In an even further embodiment, the polyol compound may include a polyether. In another further embodiment, the polyol compound may include a polysaccharide.

As indicated above, the polyol compound may include a sugar. The sugar may be glucose, sucrose, fructose, lactose, dextrose, or a mixture thereof. In one embodiment, the sugar may be glucose. In another embodiment, the sugar may be sucrose. In a further embodiment, the sugar may be fructose. In an even further embodiment, the sugar may be lactose. In a further embodiment, the sugar may be dextrose.

As indicated above, the polyol compound may include a sugar alcohol. The sugar alcohol may be glycerol, maltitol, sorbitol, mannitol, xylitol, erythritol, isomalt, threitol, arabitol, galactitol, fucitol, iditol, inositol, volemitol, lactitol, or a mixture thereof. In one embodiment, the sugar alcohol may be glycerol. In another embodiment, the sugar alcohol may be sorbitol. In a further embodiment, the sugar alcohol may be mannitol. In an even further embodiment, the sugar alcohol may be erythritol. In another embodiment, the sugar alcohol may be xylitol.

The sugar alcohol may have from 3 carbon atoms to 24 carbon atoms. For instance, the sugar alcohol may have 3 or more carbon atoms, such as 4 or more carbon atoms, such as 5 or more carbon atoms, such as 6 or more carbon atoms, such as 7 or more carbon atoms, such as 8 or more carbon atoms, such as 10 or more carbon atoms, such as 12 or more carbon atoms, such as 16 or more carbon atoms, such as 20 or more carbon atoms. The sugar alcohol may have 24 or less carbon atoms, such as 20 or less carbon atoms, such as 18 or less carbon atoms, such as 14 or less carbon atoms, such as 10 or less carbon atoms, such as 8 or less carbon atoms, such as 6 or less carbon atoms, such as 5 or less carbon atoms, such as 4 or less carbon atoms. For instance, the sugar alcohol may have 3 carbon atoms. In another embodiment, the sugar alcohol may have 4 carbon atoms. In a further embodiment, the sugar alcohol may have 5 carbon atoms. In an even further embodiment, the sugar alcohol may have 6 carbon atoms.

As indicated above, the polyol compound may include a polyether. The polyether may include polyethylene glycol, polypropylene glycol, polyglycerol, a polyglycerol ester, or a mixture thereof. In one embodiment, the polyether may include polyethylene glycol. In another embodiment, the polyether may include polypropylene glycol. In a further embodiment, the polyether may be a polyglycerol. In another embodiment, the polyether may be a polyglycerol ester. For example, the polyglycerol ester may be a fatty acid ester.

As indicated above, the polyol compound may include a polysaccharide. In general, a polysaccharide includes a large number of glucose monosaccharide units joined together by glycosidic bonds. Generally, polysaccharides can be found in plants and seeds. The polysaccharide may be chitin, chitosan, alginate, polydextrose, cyclodextrin, or a mixture thereof. In this regard, in one embodiment, the polysaccharide may be a dextrin. For instance, the dextrin may be a maltodextrin. The polysaccharide may be a starch. For instance, the starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch.

In one embodiment, the polyol compound may be a modified polyol compound. For instance, the modified polyol compound may be an ethoxylated polyol compound, an esterified polyol compound, or a mixture thereof. In one embodiment, the modified polyol compound may be an ethoxylated polyol compound. In another embodiment, the modified polyol compound may be an esterified polyol compound.

Also, it should be understood that the polyol compound may include a combination of polyol compounds, such as any of those mentioned above. For instance, it should be understood that the polyol compound may include more than one different polyol compound. For instance, in one embodiment, at least two different polyol compounds may be utilized. In another embodiment, at least three different polyol compounds may be utilized.

The polyol compound may have a relatively low molecular weight. For instance, the molecular weight may be 5,000 g/mol or less, such as 4,000 g/mol or less, such as 3,000 g/mol or less, such as 2,000 g/mol or less, such as 1,800 g/mol or less, such as 1,600 g/mol or less, such as 1,400 g/mol or less, such as 1,200 g/mol or less, such as 1,000 g/mol or less, such as 800 g/mol or less, such as 600 g/mol or less, such as 500 g/mol or less, such as 400 g/mol or less, such as 300 g/mol or less, such as 200 g/mol or less. The molecular weight may be 25 g/mol or more, such as 50 g/mol or more, such as 75 g/mol or more, such as 100 g/mol or more, such as 125 g/mol or more, such as 150 g/mol or more, such as 200 g/mol or more, such as 250 g/mol or more, such as 300 g/mol or more, such as 400 g/mol or more, such as 500 g/mol or more.

In general, a polyol may be present in the reclaim enhancing additive in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

In one aspect, the polyol may be present in the enhanced reclaim composition in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the polyol may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

### Organosilicon Compounds

In general, a reclaim enhancing additive and/or an enhanced reclaim composition may include an organosilicon compound. The organosilicon compound may comprise a silane, a polymethylhydrogensiloxane, a siloxane resin, a polysilane, an organosilanol, a disiloxane, an oligosiloxane, a polysiloxane, an organosiliconate, or a mixture thereof. In this regard, the organosilicon compound may be a micromolecule or a macromolecule. For instance, the organosilicon compound may be a network, such as a crosslinked network in one embodiment.

Suitable organosilicon compounds encompass, for example, silanes such as tetraorganosilanes SiR₄ and organoorganoxysilanes SiRₙ (OR′)₄₋ₙ with n=1 to 3, polymethylhydrogensiloxanes, siloxane resins, polysilanes preferably of the general formula R₃Si (SiR₂)ₙSiR₃ with n=0 to 500, organosilanols such as SiRₙ (OH)₄₋ₙ, disiloxanes, oligosiloxanes, polysiloxanes for example composed of units of the general formula R_{c}H_{d}Si (OR′)ₑ(OH)_{f}O_{(4-c-d-e-t)/2} with c=0 to 3, d=0 to 1, e=0 to 3, f=0 to 3, and with the sum c+d+e+f per unit being no more than 3.5, with R in each case being identical or different and denoting branched or unbranched alkyl radicals having 1 to 22 C atoms, cycloalkyl radicals having 3 to 10 C atoms, alkylene radicals having 2 to 4 C atoms, and also aryl, aralkyl, and alkylaryl radicals having 6 to 18 C atoms, and R′ denoting identical or different alkyl radicals and alkoxyalkylene radicals having in each case 1 to 4 C atoms, preferably methyl and ethyl, it also being possible for the radicals R and R′ to be substituted by halogens such as chlorine, by ether, thioether, ester, amide, nitrile, hydroxyl, amine, carboxyl, sulfonic acid, carboxylic anhydride, and carbonyl groups, and in the case of the polysilanes it also being possible for R to have the definition OR′.

Further examples of the organosilicon compounds are organosiliconates, more particularly alkyl siliconates, such as monomeric or oligomeric alkylsilanetriols. Organosiliconates are obtainable, for example, by reaction of one or more organoalkoxysilanes with one or more polyhydroxy compounds or, preferably, with one or more alkali metal lyes. Organoalkoxysilanes preferred for the preparation of organosiliconates are methyltrimethoxysilane, methyltriethoxysilane, ethyltrialkoxysilane, propyltri-methoxysilanes, butyltrimethoxysilanes, pentyltri-alkoxysilanes, hexyltrimethoxysilanes, heptyltrimethoxysilanes, octyltrimethoxysilanes. Examples of alkali metal lyes are sodium hydroxide or potassium hydroxide, more particularly in the form of their aqueous solutions. Examples of suitable polyhydroxy compounds are alkanediols, such as ethylene glycol, diethylene glycol, triethylene glycol, polyethylene glycol, 1,2-propanediol or 1,3-propanediol, alkanetriols, such as glycerol, alkanetetrols, such as pentaerythritol, hydroxycarboxylic acids, such as lactic acid, citric acid, or tartaric acid, saccharides, such as sugars, more particularly glucose, sucrose, or fructose, or starch. The reaction products may comprise basic or acidic constituents, examples being catalysts which may be added in order to promote the elimination of alkoxy groups.

Particularly preferred organosilicon compounds are methyl-trimethoxysilane, methyltriethoxysilane, ethyltrimethoxysilane, ethyltriethoxysilane, propyltrimethoxysilanes, propyltriethoxysilanes, n-butyltrimethoxysilane, isobutyltrimethoxysilane, pentyltrimethoxysilanes, hexyltrimethoxysilanes, cyclohexyltrimethoxysilane, methyltripropoxysilane, methyltri-(ethoxyethoxy) silane, vinyltri(methoxyethoxy)silane, (meth)acryloyloxypropyltrimethoxysilane, (meth)acryloyloxypro-pyltriethoxysilane, γ-chloropropyltriethoxysilane, β-nitrilo-ethyltriethoxysilane, γ-mercaPtopropyltrimethoxysilane, γ-mer-captopropyltriethoxysilane, phenyltriethoxysilane, heptyltrimethoxysilane, heptyltriethoxysilanes, isooctyltri-ethoxysilane, n-octyltriethoxysilane, hexadecyltriethoxysilanes, dipropyldiethoxysilanes, methylphenyldiethoxysilane, diphenyldimethoxysilane, methylvinyltri (ethoxyethoxy) silane, tetramethyldiethoxy-disilane, trimethyltrimethoxydisilane, trimethyltriethoxydisilane, dimethyltetramethoxydisilane, dimethyltetraethoxydisilane, methylhydrogenpolysiloxanes endblocked with trimethylsiloxy groups, copolymers endblocked with trimethylsiloxy groups and composed of dimethylsiloxane and methylhydrogensiloxane units, dimethylpolysiloxanes, and also dimethylpolysiloxanes with Si—OH groups in the terminal units.

Accordingly, the organosilicon compounds may include any of the aforementioned as well as polymers, oligomers, and/or networks formed from such compounds. For instance, such compounds may be utilized to form an oligomer, a polymer, and/or a corresponding network, all of which are encompassed by organosilicon compounds.

The organosilicon compound may be present in the reclaim enhancing additive in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

In one aspect, the organosilicon compound may be present in the enhanced reclaim composition in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the organosilicon compound may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

### Alcohol Polymers

In general, a reclaim enhancing additive and/or an enhanced reclaim composition may include an alcohol polymer. For instance, a reclaim enhancing additive and/or an enhanced reclaim composition may include polyvinyl alcohol.

The alcohol polymer may be present in the reclaim enhancing additive in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

In one aspect, the alcohol polymer may be present in the enhanced reclaim composition in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the alcohol polymer may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

### Colorants and Fertilizers

In general, a reclaim enhancing additive and/or an enhanced reclaim composition may include a colorant and/or a fertilizer.

The colorant and/or the fertilizer may be present in the reclaim enhancing additive in an amount of 0 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less.

In one aspect, the colorant and/or the fertilizer may be present in the enhanced reclaim composition in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the colorant and/or the fertilizer may be present in the enhanced reclaim composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less, such as 0.1 wt. % or less, such as 0.01 wt. % or less, such as 0.005 wt. % or less.

### ADDITIONAL DISCLOSURES

Generally, an enhanced reclaim composition may include a reclaim enhancing additive and/or any components thereof applied to and/or present on at least a portion of the surface of the reclaimed gypsum and/or the reclaimed facing material of the enhanced reclaim composition. For instance, a reclaim enhancing additive and/or any components thereof may be applied to and/or be present on the surface of the reclaimed gypsum and/or reclaimed facing material of an enhanced reclaim composition in an amount of about 1% or more of the surface area of the reclaimed gypsum and/or the reclaimed facing material, such as in an amount of about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the reclaimed gypsum and/or the reclaimed facing material.

In one aspect, the application of a reclaim enhancing additive may result in the penetration and/or embedment of a reclaim enhancing additive and/or any components thereof in any of the components of a reclaim composition, such as reclaimed gypsum and/or reclaimed facing material. Notably, the penetration and/or embedment of a reclaim enhancing additive and/or any components thereof may result in improved properties. Generally, if the reclaim enhancing additive is applied via spraying, the intensity and/or angle of the spraying and the distance of the spraying mechanism to the reclaim composition may affect the depth of penetration of the reclaim enhancing additive and/or any components thereof in the reclaimed gypsum and/or reclaimed facing material.

Generally, a reclaim enhancing additive and/or any components thereof may penetrate at least a portion of the thickness of the reclaimed gypsum and/or the reclaimed facing material of a reclaim composition to form an enhanced reclaim composition. Notably, the reclaim enhancing additive and/or any components thereof may penetrate the reclaimed gypsum and/or the reclaimed facing material of a reclaim composition by about 0% to about 100% of the thickness of the reclaimed gypsum and/or the reclaimed facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

In general, a reclaim enhancing additive may be present in an enhanced reclaim composition (e.g., a first enhanced reclaim composition, a second enhanced reclaim composition) in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 5 wt. % or more, such as 8 wt. % or more, such as 10 wt. % or more, such as 12 wt. % or more. Generally, a reclaim enhancing additive may be present in an enhanced reclaim composition (e.g., a first enhanced reclaim composition, a second enhanced reclaim composition) in an amount of 15 wt. % or less, such as 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. Additionally, in one embodiment, the aforementioned weight percentages may be based on the weight of the reclaimed gypsum in the enhanced reclaim composition. In another embodiment, the aforementioned weight percentages may be based on the weight of the reclaimed facing material in the enhanced reclaim composition.

Generally, a reclaim enhancing additive may comprise a liquid (e.g., one or more surfactants, one or more dispersants, one or more siloxanes, one or more retarders, one or more alcohols, and/or water). For instance, a liquid may be present in a reclaim enhancing additive in an amount of from about 0 wt. % to about 100 wt. %, including all increments of 0.01 wt. % therebetween. In this respect, a liquid (e.g., one or more surfactants, one or more dispersants, one or more siloxanes, one or more retarders, one or more alcohols, and/or water) may be present in a reclaim enhancing additive in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 100 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less.

Generally, a reclaim enhancing additive may have a solids content from about 0 wt. % to about to about 100 wt. %, including all increments of 0.01 wt. % therebetween. In this respect, a reclaim enhancing additive may have a solids content of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 100 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less.

Generally, an enhanced reclaim composition (e.g., a first enhanced reclaim composition, a second enhanced reclaim composition) may be present in a gypsum slurry in an amount from about 0.001 wt. % to about 80 wt. %, including all increments of 0.001 wt. % therebetween, based on the weight of the gypsum slurry.

In some aspects, an enhanced reclaim composition (e.g., a first enhanced reclaim composition, a second enhanced reclaim composition) may be present in a gypsum slurry in an amount from about 0.001 wt. % or more, such as about 0.05 wt. % or more, such as about 0.1 wt. % or more, such as about 1 wt. % or more, such as about 5 wt. % or more, such as about 10 wt. % or more, such as about 20 wt. % or more, such as about 40 wt. % or more, such as about 60 wt. % or more. In general, an enhanced reclaim composition may be present in a gypsum slurry in an amount from about 80 wt. % or less, such as about 60 wt. % or less, such as about 40 wt. % or less, such as about 20 wt. % or less, such as about 10 wt. % or less, such as about 5 wt. % or less, such as about 2 wt. % or less.

In general, a reclaim composition and/or the reclaimed gypsum of a reclaim composition may have a particular average particle size. For instance, a reclaim composition and/or the reclaimed gypsum of a reclaim composition may have an average particle size of 3 inches or less, such as 2 inches or less, such as 1 inch or less, such as 0.75 inches or less, such as 0.50 inches or less, such as 0.25 inches or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 80 microns or less, such as 75 microns or less, such as 50 microns or less, such as 40 microns or less, such as 25 microns or less, such as 20 microns or less, such as 15 microns or less, such as 10 microns or less, such as 5 microns or less. A reclaim composition and/or the reclaimed gypsum of a reclaim composition may have an average particle size of 1 micron or more, such as 5 microns or more, such as 10 microns or more, such as 20 microns or more, such as 25 microns or more, such as 40 microns or more, such as 50 microns or more, such as 75 microns or more, such as 80 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 0.25 inches or more, such as 0.50 inches or more, such as 0.75 inches or more, such as 1 inch or more, such as 2 inches or more. Furthermore, in one aspect, the aforementioned values may refer to a median particle size of the reclaim composition and/or the reclaimed gypsum of a reclaim composition. In this respect, the reclaim composition and/or the reclaimed gypsum of a reclaim composition may have a D₁₀, D₅₀, D₉₀, and/or D₉₇ of any of the values previously disclosed, including any incremental values therebetween. Notably, a reclaim composition and/or the reclaimed gypsum of a reclaim composition may be ground or milled to have a median particle size and/or average particle size from 1 micron to 3 inches, including all increments of 1 micron therebetween. It should be understood that the aforementioned values may refer to the average particle size and/or median particle size of an enhanced reclaim composition and/or reclaimed gypsum of an enhanced reclaim composition. In this respect, an enhanced reclaim composition and/or the reclaimed gypsum of an enhanced reclaim composition may have an average and/or median particle size of from 1 micron to 3 inches, including all increments of 1 micron therebetween.

In general, the gypsum core of a gypsum panel formed in accordance with the present disclosure may comprise calcium sulfate dihydrate. The gypsum used to make the gypsum core may be from a natural source, a synthetic source, and/or from reclaim, such as an enhanced reclaim composition containing reclaimed gypsum, and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry is not necessarily limited and may be any generally known in the art. Generally, in one embodiment, the gypsum core is made from a gypsum slurry including at least stucco and water.

In general, stucco may be referred to as calcined gypsum or calcium sulfate hemihydrate. The calcined gypsum may be from a natural source a synthetic source, and/or an enhanced reclaim composition and is thus not necessarily limited by the present invention. In one aspect, an enhanced reclaim composition may be combined with virgin gypsum before being calcined into stucco. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or reclaim enhancing additive may include a dispersant. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or reclaim enhancing additive may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

Notably, the gypsum slurry, gypsum core, and/or reclaim enhancing additive may include a starch. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorus acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorus acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more. The gelling temperature may be 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, gypsum, water, enhanced reclaim composition, calcined enhanced reclaim composition) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a crystalline matrix of calcium sulfate dihydrate. In this respect, the stucco may convert into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In one embodiment, the gypsum core may include a first gypsum core layer and a second gypsum core layer. The first gypsum core layer may be between the first facing material (i.e., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (i.e., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

The gypsum panel disclosed herein may have many applications. For instance, the gypsum panel may be used as a standalone panel in construction for the preparation of walls, ceilings, floors, roofing, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g, including all increments of 0.01 m2/g therebetween. For instance, the specific surface area may be 0.25 m²/g or more, such as 0.5 m²/g or more, such as 1 m²/g or more, such as 1.5 m²/g or more, such as 2 m2/g or more, such as 2.5 m²/g or more, such as 3 m2/g or more, such as 3.5 m²/g or more, such as 4 m2/g or more, such as 5 m²/g or more, such as 6 m2/g or more, such as 8 m2/g or more, such as 10 m²/g or more. The specific surface area of the gypsum core may be 15 m²/g or less, such as 10 m²/g or less, such as 8 m2/g or less, such as 6 m2/g or less, such as 4 m2/g or less, such as 3.5 m2/g or less, such as 3 m2/g or less, such as 2.5 m²/g or less, such as 2 m2/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lbr as tested according to ASTM C1396-17. The nail pull resistance may be about 400 lbr or less, such as about 300 lbr or less, such as about 200 lb_{f} or less, such as about 150 lbr or less, such as about 140 lb_{f} or less, such as about 130 lb_{f} or less, such as about 120 lbr or less, such as about 110 lb_{f} or less, such as about 105 lbr or less, such as about 100 lb_{f} or less, such as about 95 lb_{f} or less, such as about 90 lbr or less, such as about 85 lbr or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lbr or less, such as about 25 lb_{f} or less, such as about 20 lb_{f} or less, such as about 18 lbr or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lbr as tested according to ASTM C1396-17 and ASTM C₄₇₃-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A method of processing a reclaim gypsum panel and/or pieces thereof comprising:
grinding a reclaim gypsum panel and/or pieces thereof into ground reclaim material, the ground reclaim material comprising reclaimed gypsum and reclaimed facing material; and
separating the ground reclaim material into two or more reclaim compositions, the two or more reclaim compositions comprising a first reclaim composition and a second reclaim composition, the first reclaim composition comprising the reclaimed gypsum in an amount of more than about 50 wt. % and the second reclaim composition comprising the reclaimed gypsum in an amount of less than about 50 wt. %;
wherein a reclaim enhancing additive is applied to the first reclaim composition such that the reclaim enhancing additive penetrates at least a portion of the thickness of the reclaimed gypsum of the first reclaim composition.

2. The method of claim 1, wherein the reclaim enhancing additive is sprayed on the first reclaim composition.

3. The method of claim 1, wherein the application of the reclaim enhancing additive to the first reclaim composition reduces the amount of airborne dust present in the air adjacent the first reclaim composition.

4. The method of claim 1, wherein the reclaim enhancing additive comprises water in an amount of about 50 wt. % or more.

5. The method of claim 1, wherein the reclaim enhancing additive comprises water in an amount of about 80 wt. % or more.

6. The method of claim 1, wherein the reclaim enhancing additive has a solids content of about 20 wt. % or less.

7. The method of claim 1, wherein the first reclaim composition comprises reclaimed facing material, the reclaimed facing material comprising reclaimed paper, the reclaimed paper being present in the first reclaim composition in an amount of less than about 10 wt. %.

8. The method of claim 1, wherein the first reclaim composition comprises reclaimed facing material, the reclaimed facing material comprising reclaimed paper, the reclaimed paper being present in the first reclaim composition in an amount of less than about 5 wt. %.

9. The method of claim 1, wherein the reclaim enhancing additive comprises a polyol.

10. The method of claim 1, wherein the reclaim enhancing additive comprises a phosphorus containing additive.

11. A method of processing a reclaim gypsum panel and/or pieces thereof comprising:
grinding a reclaim gypsum panel and/or pieces thereof into ground reclaim material, the ground reclaim material comprising reclaimed gypsum and reclaimed facing material;
separating the ground reclaim material into two or more reclaim compositions, the two or more reclaim compositions comprising a first reclaim composition and a second reclaim composition, the first reclaim composition comprising the reclaimed gypsum in an amount of more than about 50 wt. % and the second reclaim composition comprising the reclaimed gypsum in an amount of less than about 50 wt. %; and
calcining the first reclaim composition;
wherein a reclaim enhancing additive is applied to the first reclaim composition such that the reclaim enhancing additive penetrates at least a portion of the thickness of the reclaimed gypsum of the first reclaim composition.

12. The method of claim 11, wherein the reclaim enhancing additive is sprayed on the first reclaim composition.

13. The method of claim 11, wherein the application of the reclaim enhancing additive to the first reclaim composition reduces the amount of airborne dust present in the air adjacent the first reclaim composition.

14. The method of claim 11, wherein the reclaim enhancing additive comprises water in an amount of about 50 wt. % or more.

15. The method of claim 11, wherein the reclaim enhancing additive has a solids content of about 20 wt. % or less.

16. The method of claim 11, wherein the first reclaim composition comprises reclaimed facing material, the reclaimed facing material comprising reclaimed paper, the reclaimed paper being present in the first reclaim composition in an amount of less than about 5 wt. %.

17. The method of claim 11, wherein the reclaim enhancing additive comprises a polyol.

18. The method of claim 11, wherein the reclaim enhancing additive comprises a phosphorus containing additive.

19. A method of processing a reclaim gypsum panel and/or pieces thereof comprising:
grinding a reclaim gypsum panel and/or pieces thereof into ground reclaim material, the ground reclaim material comprising reclaimed gypsum and reclaimed facing material; and
separating the ground reclaim material into two or more reclaim compositions, the two or more reclaim compositions comprising a first reclaim composition and a second reclaim composition, the first reclaim composition comprising the reclaimed gypsum in an amount of more than about 50 wt. % and the second reclaim composition comprising the reclaimed gypsum in an amount of less than about 50 wt. %;
wherein a reclaim enhancing additive is applied to the reclaim gypsum panel and/or pieces thereof before and/or during the grinding of the reclaim gypsum panel and/or pieces thereof.

20. The method of claim 19, wherein:
the application of the reclaim enhancing additive to the first reclaim composition reduces the amount of airborne dust present in the air adjacent the first reclaim composition;
the reclaim enhancing additive comprises water in an amount of about 50 wt. % or more; and
the first reclaim composition comprises reclaimed facing material, the reclaimed facing material comprising reclaimed paper, the reclaimed paper being present in the first reclaim composition in an amount of less than about 5 wt. %.
